(19) United States
(12) Patent Application Publication
(10) Pub. No.: US 2025/0180397 A1
(43) Pub. Date: Jun. 5, 2025

(54) APPARATUS AND METHOD FOR WEIGHING OBJECTS

(71) Applicant: NORDISCHER MASCHINENBAU RUD. BAADER GMBH + CO. KG, Lübeck (DE)

(72) Inventor: Julia Fleischmann, Lübeck (DE)

(21) Appl. No.: 18/842,619

(22) PCT Filed: Feb. 15, 2023
(86) PCT No.: PCT/EP2023/053711

§ 371 Date: Aug. 29, 2024

(30) Foreign Application Priority Data
Mar. 18, 2022 (EP) 22162886.0

(51) Int. Cl. G01G 21/22; G01G 9/00; G01G 19/03

(52) U.S. Cl. CPC G01G 21/22; G01G 9/00; G01G 19/03

(57) ABSTRACT

An apparatus for weighing objects of different lengths has a transport device with at least one transport element for transporting the objects in a transport direction, a weighing device arranged under the transport element, having a weighing plate with at least two weighing plate segments arranged one behind the other. The weighing plate segments each have a length. A detecting device upstream of the weighing device has at least one detecting unit for detecting the objects length. The first weighing plate segment has at least one weighing cell and generates a weighing signal of an object having a first maximum length. A downstream further weighing plate segment is connected to the first weighing plate segment by a connecting element having at least one weighing cell, and generates a weighing signal of an object having a first or second maximum length. A corresponding mention utilizes the apparatus.

### CROSS-REFERENCE TO RELATED APPLICATIONS

This application is the U.S. National Stage of PCT/EP2023/053711 filed on Feb. 15, 2023, which claims priority to European Patent Application 22162886.0 filed on Mar. 18, 2022, the entire content of both are incorporated herein by reference in their entirety.

### FIELD OF THE INVENTION

The invention relates to an apparatus, configured and adapted for weighing objects of different lengths L_{G1}, L_{G2}, L_{Gn}, in particular foodstuffs, comprising a transport device having at least one transport element, configured and adapted for transporting the objects at a transport speed in a transport direction T, a weighing device arranged under the at least one transport element, configured and adapted for determining the weight of the object transported by means of the transport device, wherein the weighing device comprises a weighing plate, comprising at least two separate weighing plate segments which are arranged under the at least one transport element one behind the other in the transport direction T, wherein the at least two weighing plate segments each have a length L_{W1}, L_{W2}, L_{Wn}, a detecting device, upstream of the weighing device in the transport direction T, comprising at least one detecting unit, configured and adapted at least to detect the length L_{G1}, L_{G2}, L_{Gn} of the objects.

The invention further relates to a method for weighing objects of different lengths L_{G1}, L_{G2}, L_{Gn}, in particular foodstuffs, comprising the steps of transporting the objects at a transport speed in a transport direction T by means of a transport device having at least one transport element, determining the weight of the objects transported by means of the transport device using a weighing device, wherein the weighing device comprises a weighing plate, comprising at least two separate weighing plate segments which are arranged under the at least one transport element one behind the other in the transport direction T, wherein the at least two weighing plate segments each have a length L_{W1}, L_{W2}, L_{Wn}, detecting the lengths L_{G1}, L_{G2}, L_{Gn} of the objects by means of a detecting device, upstream of the weighing device in the transport direction T, comprising at least one detecting unit.

### BACKGROUND OF THE INVENTION

Apparatuses and methods for weighing objects have been known from the prior art for many years, and are used in particular for specifically determining a weight of the objects in question. Such apparatuses and methods are used in a number of different branches of industry, and are necessary whenever the weight of the objects being processed is an essential process parameter.

In the industrial use of weighing apparatuses, there are fields of use in which the objects to be weighed have different lengths or widths, meaning that the dimensions of the weighing plates have to be chosen to be large enough to be able to weigh a broad variety of objects using just a single weighing device. However, such weighing devices are prone to errors, or only give reliable measurement values within a specific/narrow range of lengths of the objects. Especially in the border areas of objects that can still be detected with such weighing plates, precise weight determination is not always possible. Moreover, such weighing devices require a large amount of space since a certain length, which is only needed for a small proportion of the objects, has to be retained. Normally, one weighing plate is used per transport apparatus in the conveyor direction, which weighing plate has a defined length for a plurality of objects of different lengths. Furthermore, in terms of the objects overall, excessively long weighing plates lead to a relatively long weighing duration (duration of the objects on the weighing plate for weight determination) for the objects to be weighed, since a sufficient spacing has to be maintained between each respective object in order for only one object to be located on the weighing plate at the same time; this leads to lower throughput and an inefficient process for weighing objects.

In order to weigh objects of different widths, EP 1 952 103 B2 discloses a method and an apparatus for carrying out the method for weighing at least one object which can be moved or is moved relative to a plurality of load weighing? cells, wherein the plurality of weighing cells are arranged substantially next to one another and transversely to the direction of movement, and the weighing signals produced when weighing the at least one object can be coupled to one another. On account of the weighing cells arranged transversely to the direction of movement, such methods or devices are suitable only for weighing objects of different widths relative to the transport direction. The maximum length of the objects to be weighed is limited by the length of the weighing cell, and is not feasible for correspondingly longer objects.

In conventional apparatuses for weighing objects, when there are small spacings between objects it is not possible to weigh objects of different lengths at a constant transport speed, since the weighing plate and the spacings between the objects to be weighed have to be configured for the longest possible object in order to weigh that object completely. In this case, the length of the weighing plate is given by the maximum object length and the distance which has to be travelled in the measurement time, with an object having to be located completely on the weighing plate in order to achieve a precise measurement result. If a shorter object is then to be weighed on the same weighing plate, the spacing between the objects has to be increased by the difference in relation to the maximum product length in order for a meaningful weight to be determinable and so that two objects are not located on the weighing plate at the same time. With the known apparatuses, this leads to differences in the required spacings between the objects to be weighed, which can lead to disruptions in the processing process, particularly where there are large deviations in the lengths.

Such different lengths of objects occur particularly in the field of the foodstuffs industry, for example in the processing of natural products. The fish or meat processing industry is in particular regularly confronted with products of different size, length or weight. For example, a solution to this problem is required in the processing of white fish, since the fillet lengths vary greatly and the speed of the transport system cannot be adapted as desired in order to adapt the dwell time of a fillet on the weighing plate, since this would disrupt the overall operation of a processing line. Lower transport speeds are usually required in further process steps, as a result of which slowing down the transport speed would lead to bunching up of the fillets, which would have a negative effect on the further processing. At the same time, the spacing cannot be increased because of throughput requirements, since in this case there would be an insufficient number of fillets available at the further processing stations.

Therefore, it is an object of the present invention to provide an apparatus for weighing objects which enables reliable results when determining the weight of objects of different lengths in transport in the longitudinal direction and which at the same time provides a high throughput of objects. Another object of the present invention is to propose a corresponding method.

### SUMMARY OF THE INVENTION

This object is achieved by the apparatus mentioned hereinbefore for weighing objects by the first weighing plate segment in the course of the transport direction T comprising at least one weighing cell and being configured and adapted for generating a weighing signal of an object having a maximum length L_{G1}, and by the further weighing plate segment arranged downstream of the first weighing plate segment, in the course of the transport direction T, being connected to the first weighing plate segment by means of a connecting element which comprises at least one weighing cell, and being configured and adapted for generating a weighing signal of an object having a maximum length L_{G1} and/or L_{G2}.

The apparatus according to the invention ensures that objects of different lengths, having a maximum length L_{G1} and/or L_{G2}, which preferably corresponds in each case substantially to the maximum corresponding length of the weighing plate segments L_{W1} or L_{W1}+L_{W2}, can be weighed precisely and reliably with a single apparatus. The weighing plate comprising at least two weighing plate segments defines the weighing region for the objects. In the weighing process, smaller objects having a maximum length L_{G1} can be detected or determined by the first weighing plate segment having a length L_{W1} and can be weighed by means of the corresponding weighing cell. The weighing region for objects having a length >L_{G1} but ≤L_{G2} is provided by the first and the second weighing plate segment, so that the weight is determined by means of the connecting element comprising at least one weighing cell, which connecting element connects the first weighing plate segment to the second weighing plate segment. The length of the objects to be weighed can be detected or determined before the weighing process by means of the detecting unit, and therefore, depending on the length of the objects, in each case the corresponding weighing cell provided for the weighing range of the objects can be used for weight determination. Smaller objects having a maximum length L_{G1} are detected or determined by the first weighing cell in the transport direction T, while objects having a length >L_{G1} but ≤L_{G2} can be detected or determined by means of the second weighing cell in the transport direction T; this detects/determines the weight force of the connecting element and therefore weighs the object on the first and the second weighing plate segment. The configuration according to the invention of the weighing device in conjunction with the transport device firstly enables measurement while moving, which is a significant advantage over the previously known weighing apparatuses. The novel construction makes it possible to achieve quicker transport speeds with constant, and valid, weight determination. Furthermore, the selection of the corresponding weighing cell enables flexible detect of the weight of the objects on the basis of the corresponding length. A plurality of weighing plate segments connected one behind the other makes it possible to considerably reduce the minimum spacings between the objects needed for weighing. Smaller objects having a maximum length L_{G1} do not have to be arranged on the entire weighing plate; rather, it is sufficient for them to be located just on the first weighing plate segment for weight determination. Since such apparatuses are preferably provided for weighing objects provided in a stream, determining the weight of subsequent objects can take place sooner, since the weighing process of the object having the maximum length L_{G1} has already been concluded by the weight determination of the first weighing cell, and subsequent objects can pick up the weighing process by being provided in the detecting unit. In this way, the spacing between the objects can be reduced and the subsequent object to be weighed can in turn be weighed, depending on its length (L_{G1}, L_{G2} or L_{Gn}), by the weighing cell of the first weighing plate segment or the weighing cell of the connecting element. Preferably, the length of each connecting element corresponds substantially to half the combined lengths of all the weighing plate segments connected by the connecting element.

For the purpose of the invention, “objects” are all objects or products which are suitable or provided for weight determination. Such objects are also known by the terms products, goods, wares, etc. The objects are preferably food which has different deviations in length and/or weight. The objects to be weighed are particularly preferably raw or intermediate animal products, particularly fish or fish fillets.

The apparatus is provided for weighing objects having different lengths and/or widths. In this regard, length means the extent of the objects in the longitudinal orientation relative to the transport direction T, with objects having different widths being equally weighable by the apparatus but being conveyed with their width substantially transverse to the transport direction T. The width of the objects is of lesser relevance to the invention, as long as the width of the objects does not exceed the width of the weighing plate or the weighing plate segments.

It is advantageous for reliable weighing of the objects if a certain minimum spacing between the objects is not undershot. In particular, the minimum spacing is selected such that the weighing cell carries out constant weight determination of the corresponding object on the basis of the length thereof. In each case, the weighing cell of that weighing device for which the weighing plate segment length, or the combined weighing plate segment length, is substantially less than and/or equal to the length of the object, is provided for weight determination. In other words, this means that, in each case, that weighing plate segment or those weighing plate segments of the weighing plate which correspond(s) to greater than or equal to the length of the object is/are provided, in addition to a required weighing length necessary for the weight determination by means of the weighing cell.

A preferred embodiment is characterised in that each further weighing plate segment arranged downstream in the course of the transport direction T is connected at least to the preceding connecting element by means of a further connecting element comprising at least one weighing cell, and is configured and adapted for generating a weighing signal of an object having a maximum length L_{G1} and/or L_{G2} and/or L_{Gn}. The formation of a plurality of connecting elements which are each configured and adapted to determine the weight of objects having a corresponding length using the last weighing plate segment in the transport direction, enables further flexibility in weighing processes using the weighing apparatus for objects of different lengths. Subdividing the weighing plates into weighing plate segments of different lengths L_{W1}, L_{W1}+L_{W2} or L_{W1}+L_{W2}+L_{Wn} on the one hand increases the possibility of determining the weight of objects having a broad variety of lengths L_{G1}, L_{G2} and L_{Gn} and on the other hand makes it possible, by means of the segmentation into different sub-regions, to carry out individual and specific weight determination by the respective weighing plate segments having the corresponding length of the objects. This also provides the possibility of reducing the spacing between the objects to be weighed, in order to avoid reductions in throughput. Thus, the spacing between the objects to be weighed can be chosen to be as small as possible, increasing the throughput in the weighing process and also in the downstream processing steps.

An advantageous development is characterised in that the first and/or the second weighing plate segment arranged in the course of the transport direction T is connected in a mechanically supported manner to the first connecting element arranged in the course of the transport direction T and is configured and adapted for transmitting a weight force. This results in a secure, simple and cost-effective possibility for transmitting weight force between the corresponding connecting element and the associated weighing plate segment, in order to provide reliable transmission of the weight force. Alternatively or in addition, the term connecting element should more preferably be understood to mean sensor-assisted or computed connections. In a further preferred embodiment, the weight force is generated and/or transmitted by means of digital measurement and/or computing methods.

In a further advantageous configuration of the invention, the first connecting element in the transport direction T is connected to the weighing cell of the first weighing plate segment. Thus, the weight force can either be directly derived from the data generated by the weighing cell and/or alternatively a mechanical transmission is provided in the region of the weighing cell. The weighing cell is preferably arranged centrally under the first weighing plate segment in order to achieve the best measurement results; this also results in a preferential arrangement for the transmission of the weight force by means of the connecting element.

An expedient configuration of the invention is characterised in that the length L_{G1} of the objects is less than and/or equal to the length L_{W1} of the first weighing plate segment and in that the length L_{G2} of the objects is less than and/or equal to the length L_{W1}+L_{W2} of the first weighing plate segment and of the second weighing plate segment, and in that the length L_{Gn} of the objects is less than and/or equal to the length L_{W1}+L_{W2}+L_{Wn} of the first weighing plate segment, of the second weighing plate segment and of the or each further weighing plate segment. “L_{Gn}” or “L_{Wn}” represent further lengths, according to the invention, of objects to be weighed by means of the apparatuses, and lengths of possible further weighing plate segments, respectively. The further object or the further objects having the length L_{Gn} has or have a greater length than L_{G1} or L_{G2}. The further weighing plate segment or the further weighing plate segments having the length L_{Wn} preferably has or have a non-specific length, or the length of the further weighing plate segments L_{Wn} is not essential to the invention. In total, however, the weighing plate segments L_{W1}+L_{W2}+L_{Wn} are longer than L_{W1} or L_{W1}+L_{W2}. The corresponding length of the objects and the weighing plate segments enables simple and reliable specific weight determination of the objects in question. The detecting unit detects the length of the objects, as a result of which the weighing cell of the corresponding weighing plate segment or the weighing cell of the corresponding connecting element is selected. The length of the object to be weighed is preferably less than the length of the corresponding weighing plate segment or less than the length of the corresponding weighing plate segments, since some delays may arise in the weighing process at a transport speed. It is necessary for the measurement process that the object is lying completely on the weighing plate, which can be reliably ensured when the length of the weighing plate or the length of the weighing plate segment(s) correspond(s) completely to the length of the object or when the length of the weighing plate or the length of the weighing plate segment(s) is greater than the length of the object, particularly at high transport speeds, wherein an additional weighing distance should optionally be taken into account, which weighing distance results from the required weighing time in conjunction with the transport speed (conveyor speed). The length of the weighing plate and/or of the weighing plate segment(s) must be chosen to be sufficiently large for precise and valid weights to be able to be determined, by the dwell time of the objects located completely on the weighing plate being chosen to be sufficiently large. In other words, in each case an additional weighing length between object and weighing plate is required, which weighing length is in proportion to the transport speed as well as the measuring duration and is chosen to be sufficiently large to configure and adapt detect of the weight by means of the corresponding weighing cell. This required weighing length represents the minimum difference between the length of the objects and the length of the weighing plate, as a result of which for example L_{G1}<L_{W1}.

In a preferred embodiment, the transport speed can be configured and adapted to be reducible at least during the weighing process. The transport speed during the weighing process of the objects is preferably substantially 0. In this way, the spacing between the objects can be reduced and the length of the objects can substantially correspond to the length of the weighing plate segments or the sum of the weighing plate segments.

According to a further preferred embodiment of the invention, the weighing plate comprises three to seven weighing plate segments wherein, starting from the second weighing plate segment in the course of the transport direction T, in each case a connecting element is provided for connecting at least one weighing plate segment to the connecting element. This further increases the range of use as well as the accuracy and efficiency of the apparatus, because, on the one hand, a more detailed subdivision of the weighing plates can take place by increasing the number of weighing plate segments and, on the other hand, greater lengths of objects can be weighed. The length of the corresponding weighing plate segments is fundamentally unimportant and can either be used to produce a large overall length or to carry out specific subdivision in a region or regions. In this way, the apparatus can, as required, weigh a broad range of different lengths and also reduce the spacing of the objects relative to one another, since the lengths of the weighing plate segments are chosen with respect to the variation of the objects.

A further expedient configuration of the invention is characterised in that the detecting unit is configured and adapted as a scanning system, wherein the scanning system preferably comprises at least one camera and/or at least one laser measuring device. The scanning system provides a simple option for determining or detecting the length of the objects. The scanning system preferably comprises digital measurement methods, it also being possible, alternatively or in addition, to provide analogue detecting units in order to detect the length of the objects. The detecting unit is preferably configured and adapted to detect the specific length of the objects. The term scanning system should further be understood to mean a radiation device, for example a system comprising an X-ray unit which is configured and adapted for generating an X-ray image of the objects. The detecting unit is further preferably configured and adapted as an imaging detecting unit, for example as an X-ray system for determining the object lengths.

A preferred development of the invention is characterised in that at least one of the connecting elements is configured and adapted to be plate-like. Plate-like connecting elements offer a number of possibilities for transferring weight force and are preferably suitable for calculating the forces arising. The plate-like connecting elements are preferably elongate or planar elements having defined transmission points for the weight forces to be transferred or for the provided weighing cells.

An expedient configuration of the invention is characterised in that the connection between at least one of the connecting elements and at least one of the weighing plate segments is configured and adapted by means of at least two load elements running substantially parallel to one another. The load elements serve for the transmission of the corresponding weight force from the corresponding weighing plate segment to the connecting element. The load elements running parallel to one another substantially enables a uniform and/or calculable transmission of weight force, in order to provide reliable determination of the object transported on the weighing plate.

An advantageous development is characterised in that the load elements running substantially parallel to one another are configured and adapted substantially orthogonally to the transport element. This enables direct force transmission of the load elements and makes it possible to undertake simple calculation of the corresponding forces.

In a further preferred development of the invention, the objects according to the invention are fish fillets having a length of 200 mm to 900 mm. This provides the possibility of weighing common sizes of fish fillets. The invention is however equally suited to weighing further objects in lengths which deviate from common sizes of fish fillets. The lengths of the weighing plate segments can be chosen variably, in order to provide a desired overall length. For example, the weighing plate segments may have the lengths 600 mm, 200 mm and 200 mm, as a result of which the apparatus could be configured for weighing objects having a length in the range from 200 to 900 mm. A further parameter here is generally the transport speed or conveyor speed, which in the present example could be at most 600 mm/s. In the present example, with a length range from 200 mm up to 500 mm inclusive, only the first weighing plate segment and thus the first weighing cell is considered. In the length range from 500 mm to 700 mm inclusive, the first two weighing plate segments and hence the weighing cell of the first connecting element are considered. In the length range from 700 mm to 900 mm inclusive, all three weighing plate segments and only the third weighing cell, i.e. the weighing cell of the second connecting element, are considered.

In a further advantageous configuration of the invention, on the basis of the lengths L_{G1}, L_{G2}, L_{Gn} of the object detected by the detecting unit, the corresponding weighing signal of the corresponding length L_{W1}, L_{W1}+L_{W2} or L_{W1}+L_{W2}+L_{Wn} of the weighing plate segments can be used for weight determination. Preferably, in each case only the weighing signal is provided of the corresponding weighing cell for which the length substantially corresponds to, or is greater than, the length of the object to be weighed. Potential measurement values from further weighing cells are preferably not taken into account for the weight determination. Further preferably, the weight determination of the objects is based in each case on just a single weighing cell, the weight of which can be actively generated via the corresponding weighing plate segment or via the corresponding connecting element in combination with the respective weighing plate segment(s).

A further expedient configuration of the invention is characterised in that the transport speed is configured and adapted to be controllable and/or regulable on the basis of the length L_{G1}, L_{G2}, L_{Gn} of the objects and/or the length L_{W1}, L_{W2}, L_{Wn} of the weighing plate segments. The transport speed of the objects to be transported usually has a considerable influence on the (minimum) spacings to be formed between the objects. In principle, there is a need to configure and adapt a larger spacing between the objects at high transport speeds than at slower transport speeds. Depending on the weighing cells used, it is required for the object to remain on the weighing plate or in the weighing region of the weighing plate for a specified length of time. The controllability and/or regulability makes it possible to optimally adapt the transport speed on the basis of the respective lengths of the objects, in order to maintain desired spacings between the objects so that meaningful and valid weighing results can be achieved.

An advantageous development of the invention is characterised in that the objects can be arranged spaced apart from one another on the transport element, wherein the spacing from one another is configured and adapted to be adjustable on the basis of the length L_{G1}, L_{G2}, L_{Gn} of the objects and/or the length L_{W1}, L_{W1}+L_{W2} or L_{W1}+L_{W2}+L_{Wn} of the weighing plate segments and/or the transport speed. For example, a minimum spacing between the objects is provided in order to obtain a sufficient spacing during the weighing processes, so that no erroneous measurements are carried out. The minimum spacing may be different depending on the transport speed. At higher speeds, a greater spacing is generally required.

A further expedient configuration of the invention is characterised in that the spacing between the objects is configured and adapted to be substantially constantly adjustable independently of the length of the objects L_{G1}, L_{G2}, L_{Gn} and/or the length L_{W1}, L_{W2}, L_{Wn} of the weighing plate segments and/or the transport speed. This results in an improved intended purpose for potential downstream processing steps, as a result of which in particular the efficiency of such apparatuses and facilities is improved. Such weighing apparatuses are usually integrated, or can be integrated, in facilities with several steps which each contain processes that build on one another. It is advantageous for further processing when a constant output of objects can be produced, in order to ensure a smooth, time-efficient and constant ongoing process.

In a preferred embodiment, the apparatus further comprises at least one control and/or computing unit, which is configured and adapted to provide a weight determination by the weighing device on the basis of the lengths L_{G1}, L_{G2}, L_{Gn} of the objects detected by the detecting unit, wherein in each case the corresponding weighing plate segment/weighing plate segments having the length L_{W1}, L_{W1}+L_{W2} or L_{W1}+L_{W2}+L_{Wn} can be selected for generating a weighing signal, preferably automatically or in an automatable manner, the length of which or the sum of the lengths of which corresponds to the length L_{G1}, L_{G2}, L_{Gn} of the objects.

Further preferably, the weighing cell is at least substantially configured and adapted centrally with respect to the weighing region of the corresponding object. The weighing cell is preferably configured and adapted centrally with respect to the weighing plate. The or each weighing cell is further preferably configured and adapted such that it is in each case configured and adapted centrally with respect to the corresponding weighing plate segment or weighing plate segments, in order to receive the force from the object located on the weighing plate at least substantially in the centre.

The object is also achieved by the method mentioned hereinbefore by the weighing signal of an object of a maximum length L_{G1} being generated by means of a weighing cell comprising a first weighing plate segment in the course of the transport direction T, and by a weighing signal of an object of a maximum length L_{G1} and/or L_{G2} being generated by means of the weighing plate segment, comprising at least one weighing cell, downstream of the first weighing plate segment in the course of the transport direction T, wherein the first weighing plate segment is connected to the downstream weighing plate segment by means of a connecting element.

To avoid repetition, reference is made, in the context of the method according to the invention, to the preferences already set out in detail with respect to the apparatus according to the invention. These apply analogously to the method according to the invention stated below.

A development is characterised in that a weighing signal of an object of a maximum length L_{G1} and/or L_{G2} and/or L_{Gn} is generated by means of each further weighing plate segment, comprising at least one weighing cell, downstream in the course of the transport direction T, wherein each further weighing plate segment comprises in each case one connecting element and is connected to the preceding connecting element.

In a further advantageous configuration of the invention, the first and/or the second weighing plate segment arranged in the course of the transport direction T is connected in a mechanically supported manner to the first connecting element arranged in the course of the transport direction T, a weight being transmitted.

An expedient configuration of the invention is characterised in that the first connecting element in the transport direction T is connected to the weighing cell of the first weighing plate segment.

A further preferred embodiment of the invention is characterised in that the length L_{G1} of the objects is less than and/or equal to the length L_{W1} of the first weighing plate segment and in that the length L_{G2} of the objects is less than and/or equal to the length L_{W1}+L_{W2} of the first weighing plate segment and of the second weighing plate segment, and in that the length L_{Gn} of the objects is less than and/or equal to the length L_{W1}+L_{W2}+L_{Wn} of the first weighing plate segment, of the second weighing plate segment and of the or each further weighing plate segment.

A further expedient configuration of the invention is characterised in that at least one of the connecting elements and at least one of the weighing plate segments are connected by means of at least two load elements running substantially parallel.

A preferred development of the invention is characterised in that the objects are fish fillets having a length of 200 mm to 900 mm.

A further expedient configuration of the invention is characterised in that, on the basis of the lengths L_{G1}, L_{G2}, L_{Gn} of the object detected by the detecting unit, the corresponding weighing signal of the corresponding length L_{W1}, L_{W1}+L_{W2} or L_{W1}+L_{W2}+L_{Wn} of the weighing plate segments is used for weight determination.

A preferred development of the invention is characterised in that the transport speed is controlled and/or regulated on the basis of the length L_{G1}, L_{G2}, L_{Gn} of the objects and/or the length L_{W1}, L_{W2}, L_{Wn} of the weighing plate segments.

According to a further preferred embodiment of the invention, the objects are arranged spaced apart from one another on the transport element, wherein the spacing from one another is adjusted on the basis of the length L_{G1}, L_{G2}, L_{Gn} of the objects and/or the length L_{W1}, L_{W2}, L_{Wn} of the weighing plate segments and/or of the transport speed.

In a preferred embodiment, the spacing between the objects is substantially constantly adjusted independently of the length of the objects L_{G1}, L_{G2}, L_{Gn} and/or the length L_{W1}, L_{W2}, L_{Wn} of the weighing plate segments and/or the transport speed.

The advantages and effects resulting from the invention have already been described in conjunction with the apparatus, and therefore reference is made to the previous passages in order to avoid repetitions.

### BRIEF DESCRIPTION OF THE DRAWINGS

Further expedient and/or advantageous features and developments to the apparatus according to the invention, and also to the method, result from the dependent claims and the description. Particularly preferred embodiments of the apparatus and of the method are described in more detail using the appended drawings. The drawings show:

FIG. 1 a schematic side view of an apparatus according to the invention;

FIG. 2 a further side view of the apparatus shown in FIG. 1, with an object having the length L_{G1};

FIG. 3 a further side view of the apparatus shown in FIG. 1, with an object having the length L_{G2}; and

FIG. 4 a further side view of the apparatus shown in FIG. 1, with an object having the length L_{Gn} or L_{G3}.

### DETAILED DESCRIPTION OF THE INVENTION

Said figures will be used to describe the apparatus for weighing objects according to the invention in more detail.

The objects shown in the drawings are depicted by way of example as schematic fish fillets. The invention likewise relates to comparable objects which are not part of the food or food processing industries.

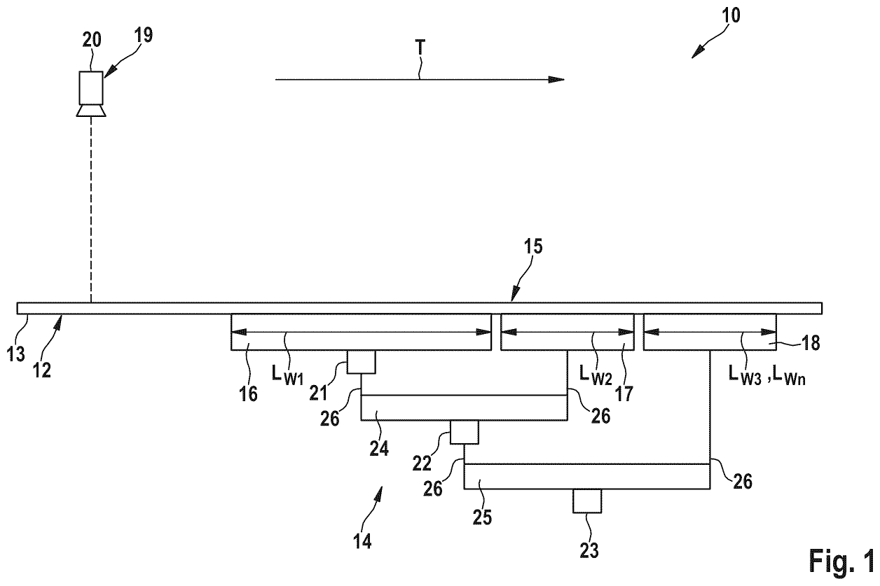

FIG. 1 to FIG. 4 each schematically depict an embodiment of an apparatus 10 for weighing objects 11 of different lengths L_{G1}, L_{G2}, L_{Gn}, in particular foodstuffs, comprising a transport device 12 having at least one transport element 13, configured and adapted for transporting the objects 11 at a transport speed in a transport direction T, a weighing device 14 arranged under the at least one transport element 13, configured and adapted for determining the weight of the object 11 transported by means of the transport device 12, wherein the weighing device 14 comprises a weighing plate 15, comprising at least two separate weighing plate segments 16, 17, 18 which are arranged under the at least one transport element 13 one behind the other in the transport direction T, wherein the at least two weighing plate segments 16, 17, 18 each have a length L_{W1}, L_{W2}, L_{Wn}, a detecting device 19, upstream of the weighing device 14 in the transport direction T, comprising at least one detecting unit 20, configured and adapted at least to detect the length L_{G1}, L_{G2}, L_{Gn} of the objects 11.

According to the invention, this apparatus 10 is characterised in that the first weighing plate segment 16 in the course of the transport direction T comprises at least one weighing cell 21 and is configured and adapted for generating a weighing signal of an object 11 having a maximum length L_{G1}, and in that the further weighing plate segment 17 arranged downstream of the first weighing plate segment 16, in the course of the transport direction T, is connected to the first weighing plate segment 16 by means of a connecting element 24 comprising at least one weighing cell 22, and is configured and adapted for generating a weighing signal of an object 11 having a maximum length L_{G1} and/or L_{G2}.

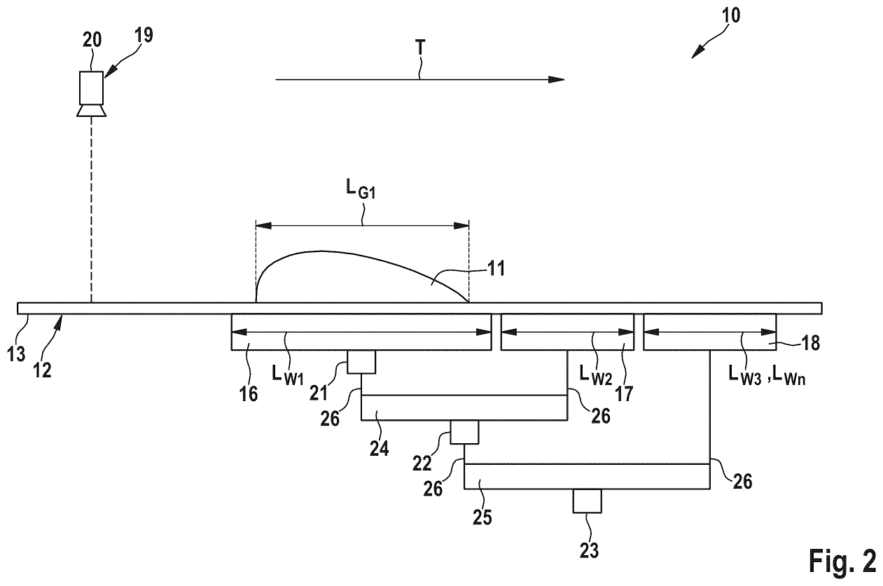

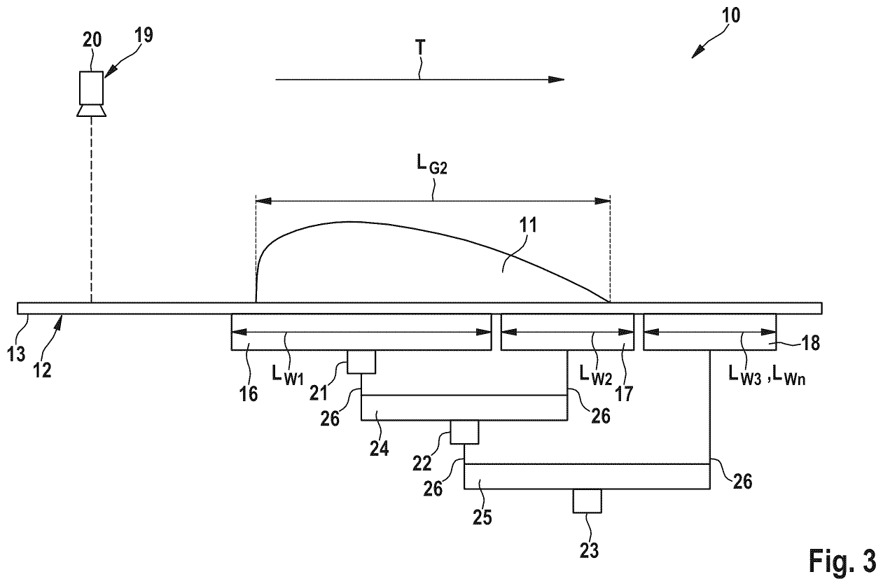

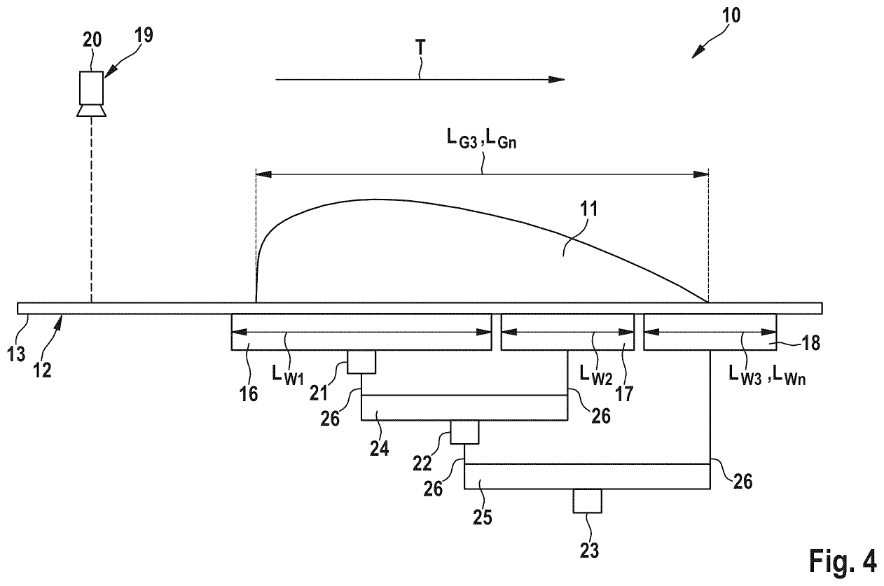

FIG. 1 depicts a side view of an apparatus 10 according to the invention for weighing objects 11. Such apparatuses 10 are usually integrated in industrial facilities or machines—not shown—in order to carry out the processes according to the invention in conjunction with the apparatus 10. Of course, however, independent use of such apparatuses 10 is also possible. The apparatuses 10 according to the invention are generally arranged on a planar underlying surface—not shown in the figures—in order to form the weighing plate 15 and the transport element 13 substantially parallel to the underlying surface. FIG. 1 shows an embodiment according to the invention of the apparatus 10 without any objects to be weighed, whereas FIG. 2, FIG. 3 and FIG. 4 show the apparatus 10 of FIG. 1 in each case with objects 11 of different lengths. In FIG. 1 to FIG. 4, the weighing plate 15 has, by way of example, three weighing plate segments 16, 17, 18, the corresponding three weighing plate segments 16, 17, 18 each having a defined length L_{W1}, L_{W2}, L_{Wn} or L_{W3}. Such apparatuses 10 are not limited to weighing plates 15 having two or three weighing plate segments 16, 17, 18 each having a defined length L_{W1}, L_{W2}, L_{Wn} or L_{W3}. The designation of the length L_{Wn} means that further weighing plate segments 16, 17, 18 can be included, each having an independent defined length L_{Wn}. Specific size or length information is not essential to the invention. Furthermore, the objects 11 to be weighed are likewise not of particular relevance to the invention. If special objects 11, for example from the field of the food or animal-processing industries, are to be weighed by means of the apparatus 10, special adaptations to the apparatus 10 may be necessary. Such adaptations may for example be water resistance of the components, or special materials such as food-safe plastics or stainless steel components.

For weighing, the objects 11 are transported over the weighing plate 15 by means of the transport element 13, the object 11, depending on the length thereof, lying completely on at least one of the weighing plate segments 16, 17, 18 in the longitudinal orientation, as a result of which the correspondingly associated weighing cell 21 generates a weighing signal of the object 11. At a maximum length L_{G1} of the object 11, as depicted in FIG. 2, the object 11 is lying completely on the weighing plate segment 16 having the length L_{W1}, as a result of which the associated weighing cell 21 generates a weighing signal which is provided for determining or for detecting the weight or the weight force of the corresponding object 11 having the length L_{G1}. At a length L_{G2} of the object 11, as depicted in FIG. 3, the object 11 is lying completely on the weighing plate segments 16 and 17 having the length L_{W1} and L_{W2}, as a result of which the weighing cell 22 of the connecting element 24 generates a weighing signal which is provided for determining or for detecting the weight or the weight force of the corresponding object 11 having the maximum length L_{G2}.

Preferably, each further weighing plate segment 18 arranged downstream in the course of the transport direction T is connected at least to the preceding connecting element 24 by means of a further connecting element 25 comprising at least one weighing cell 23, and is configured and adapted for generating a weighing signal of an object 11 having a maximum length L_{G1} and/or L_{G2} and/or L_{Gn} FIG. 4 shows, by way of example, an object 11 having the length L_{Gn} and Les and lying completely on the weighing plate segments 16, 17, 18 having the length L_{W1}, L_{W2} and L_{Wn} or L_{W3}, as a result of which the weighing cell 23 associated with the second connecting element 25 generates a weighing signal which is provided for determining or for detecting the weight or the weight force of the corresponding object 11 having the length L_{G3} and L_{Gn}. If one or each further potentially present weighing cell 21, 22 of the apparatus 10 likewise generate(s) a weighing signal, this weighing signal or these weighing signals are not taken into account for the weight determination, since preferably the weight of the object 11 can be determined only on the basis of the length determined by the detecting device 19 in each case by means of the corresponding weighing cell 21, 22, 23.

In an advantageous embodiment, the first and/or the second weighing plate segment 16, 17 arranged in the course of the transport direction T is connected in a mechanically supported manner to the first connecting element 24 arranged in the course of the transport direction T and is configured and adapted for transmitting a weight force. Further preferably, the first connecting element 24 in the transport direction T is connected to the weighing cell 21 of the first weighing plate segment 16. FIG. 1 to FIG. 4 each depict a connection between the first weighing plate segment 16 and the first connecting element 24. The connection here is produced by a direct connection to the weighing cell 21 of the first weighing plate segment 16.

Preferably, the length L_{G1} of the objects 11 is less than and/or equal to the length L_{W1} of the first weighing plate segment 16 and the length L_{G2} of the objects 11 is less than and/or equal to the length L_{W1}+L_{W2} of the first weighing plate segment 16 and of the second weighing plate segment 17, and the length L_{Gn} of the objects 11 is less than and/or equal to the length L_{W1}+L_{W2}+L_{Wn} of the first weighing plate segment 16, of the second weighing plate segment 17 and of the or each further weighing plate segment 18. FIG. 1 to FIG. 4 show just three weighing plate segments 16, 17, 18 by way of example. In further preferred configurations, which however are not shown in the figures, a weighing plate 15 having more than three weighing plate segments 16, 17, 18 each with a length range L_{W1}, L_{W2}, L_{W3} can be provided, which are configured and adapted for weighing objects 11 having more than three length ranges L_{G1}, L_{G2}, L_{G3}. Preferably, the weighing plate 15 comprises three to seven weighing plate segments 16, 17, 18 wherein, starting from the second weighing plate segment 16, 17 in the course of the transport direction T, in each case a connecting element 24, 25 is provided for connecting at least one weighing plate segment 16, 17, 18 to the connecting element 24, 25. If, therefore, more than three weighing plate segments 16, 17, 18 are provided, in each case a further connecting element 24, 25 is provided for connecting the additional weighing plate segment and the corresponding connecting element.

The three weighing plate segments 16, 17, 18 shown in FIG. 1 to FIG. 4 have, for example, a length of 600 mm, 200 mm and 200 mm. Such lengths are particularly suitable for an object length range of 200 mm to 900 mm at a maximum conveyor speed of 600 mm/s. In the object length range from 200 mm up to 500 mm inclusive, only the first weighing plate segment 16 and thus the first weighing cell 21 is considered. In the length range from 500 mm to 700 mm inclusive, the first two weighing plate segments 16, 17 and hence the second weighing cell 22 of the first connecting element 24 are considered. And, in the length range from 700 mm to 900 mm inclusive of the objects 11, all three weighing plate segments 16, 17, 18 and only the third weighing cell 23 of the second connecting element 25 are considered. As indicated in FIG. 2 to FIG. 4, the objects 11 are preferably fish fillets having a length of 200 mm to 900 mm.

The detecting unit 20 shown schematically in FIG. 1 to FIG. 4 is preferably configured and adapted as a scanning system, wherein the scanning system preferably comprises at least one camera and/or at least one laser measuring device. Further preferably, the detecting unit 20 can also be configured and adapted as a photoelectric sensor, motion sensor, etc., preferably arranged at the level of the objects 11 to be weighed. FIG. 1 to FIG. 4 depict possible radiation, waves or the like in a stylised manner as dots which are intended to demonstrate the process of detecting during the length determination.

The connecting elements 24, 25 are preferably each located in a further plane under the weighing plate segments 16, 17, 18. In preferred embodiments, at least one of the connecting elements 24, 25 is configured and adapted to be plate-like. Each of the connecting elements 24, 25 are configured to be plate-like in FIG. 1 to FIG. 4 in order to ensure reliable reception and transmission of force. Preferably, the connection between at least one of the connecting elements 24, 25 and at least one of the weighing plate segments 16, 17, 18 is configured and adapted by means of at least two load elements 26 running substantially parallel to one another. In an advantageous configuration, the load elements 26 running substantially parallel to one another are configured and adapted to be substantially orthogonal to the transport element 13. Further preferably, the load elements 26 are likewise configured and adapted to be substantially orthogonal to the weighing plate 15. The transport element 13 and the weighing plate 15 are preferably arranged substantially parallel to one another.

A further advantageous embodiment of the apparatus 10 according to the invention is characterised in that, on the basis of the lengths L_{G1}, L_{G2}, L_{Gn} of the object 11 detected by the detecting unit 20, the corresponding weighing signal of the corresponding length L_{W1}, L_{W1}+L_{W2} or L_{W1}+L_{W2}+L_{Wn} of the weighing plate segments 16, 17, 18 can be used for weight determination. In FIG. 2 to FIG. 4, therefore, in each case only the weighing signal from the corresponding weighing cell 21, 22, 23 which completely detects the corresponding object 11 should be taken into account for weight determination.

In an advantageous embodiment of the apparatus 10 according to the invention, the transport speed is configured and adapted to be controllable and/or regulable on the basis of the length L_{G1}, L_{G2}, L_{Gn} of the objects 11 and/or the length L_{W1}, L_{W2}, L_{Wn} of the weighing plate segments 16, 17, 18. In particular, the transport speed can be controlled and/or regulated by means of the transport device 12. To this end, the apparatus 10 or the transport device 12 can comprise further means, for example drive units and/or control units, in order to provide a variable transport speed for the objects 11. To this end, the apparatus 10 further preferably comprises at least one regulating and/or control unit, not depicted in more detail in the figures. Further preferably, the objects 11 can be arranged spaced apart from one another on the transport element 13, wherein the spacing from one another is configured and adapted to be adjustable on the basis of the length L_{G1}, L_{G2}, L_{Gn} of the objects 11 and/or the length L_{W1}, L_{W2}, L_{Wn} of the weighing plate segments 16, 17, 18 and/or the transport speed. To this end, the apparatus 10 can preferably comprise a feed device—not shown—in order to provide the objects 11 on the transport element 13 on the basis of their detected length, the transport speed and/or the length of the weighing plate segments 16, 17, 18. Advantageously, the spacing between the objects 11 can be configured and adapted to be substantially constantly adjustable independently of the length of the objects 11 L_{G1}, L_{G2}, L_{Gn} and/or the length L_{W1}, L_{W2}, L_{Wn} of the weighing plate segments 16, 17, 18 and/or of the transport speed.

In an advantageous embodiment, the lengths L_{W1}, L_{W2}, L_{Wn} of the weighing plate segments 16, 17, 18 are configured and adapted according to a frequency distribution of possible occurring lengths L_{G1}, L_{G2}, L_{Gn} of the objects 11 to be weighed, the frequency distribution being formed from known, predetermined and/or estimated parameters. Further preferably, the lengths L_{W1}, L_{W2}, L_{Wn} of the weighing plate segments 16, 17, 18 are configured and adapted on the basis of the provided transport speed.

The method is described in more detail below using the drawing. The method serves for weighing objects 11 of different lengths L_{G1}, L_{G2}, L_{Gn}, in particular foodstuffs, comprising the steps of transporting the objects 11 at a transport speed in a transport direction T by means of a transport device 12 having at least one transport element 13, determining the weight of the objects 11 transported by means of the transport device 12 using a weighing device 14, wherein the weighing device 14 comprises a weighing plate 15, comprising at least two separate weighing plate segments 16, 17, 18 which are arranged under the at least one transport element 13 one behind the other in the transport direction T, wherein the at least two weighing plate segments 16, 17, 18 each have a length L_{W1}, L_{W2}, L_{Wn}, detecting the length L_{G1}, L_{G2}, L_{Gn} of the objects 11 by means of a detecting device 20, upstream of the weighing device 14 in the transport direction T, comprising at least one detecting unit 20.

This method is characterised according to the invention in that the weighing signal of an object 11 of a maximum length L_{G1} is generated by means of a weighing cell 21 comprising a first weighing plate segment 16 in the course of the transport direction T, and in that a weighing signal of an object 11 of a maximum length L_{G1} and/or L_{G2} is generated by means of the weighing plate segment 17, comprising at least one weighing cell 22, downstream of the first weighing plate segment 16 in the course of the transport direction T, wherein the first weighing plate segment 16 is connected to the downstream weighing plate segment 17 by means of a connecting element 24. The connecting element 24 enables the force from the first weighing plate segment 16 and the second weighing plate segment 25 to be received in a shared manner, in order to be detected in the weighing cell 22 of the connecting element 24. The objects 11 having the length L_{G2}, which are larger than the first weighing plate segment 16, can thus be weighed by means of the method. The method is depicted particularly by FIG. 3.

Preferably, a weighing signal of an object 11 of a maximum length L_{G1} and/or L_{G2} and/or L_{Gn} is generated by means of each further weighing plate segment 16, 17, 18, comprising at least one weighing cell 21, 22, 23, downstream in the course of the transport direction T, wherein each further weighing plate segment 18 comprises in each case one connecting element 25 and is connected to the preceding connecting element 24. FIG. 1 to FIG. 4 each depict a general construction of an apparatus 10 for carrying out the method according to the invention, which apparatus comprises three weighing plate segments 16, 17, 18 and two connecting elements 24, 25. The objects 11 are transported over the weighing plate 15 in transport direction T at a transport speed by means of the transport element 13. In the process, firstly the length of the objects 11 is detected by means of the detecting unit 20, in order to carry out weight determination by means of the corresponding weighing cell 21, 22, 23 on the basis of the length L_{G1}, L_{G2}, L_{Gn} of the objects 11. Preferably, the objects 11 are fish fillets having a length of 200 mm to 900 mm.

Preferably, the first and/or the second weighing plate segment 16, 17 arranged in the course of the transport direction T is connected in a mechanically supported manner to the first connecting element 24 arranged in the course of the transport direction T, a weight force being transmitted. FIG. 1 to FIG. 4 each schematically show corresponding connections. Further preferably, the first connecting element 24 in the transport direction T is connected to the weighing cell 21 of the first weighing plate segment 16. Preferably, at least one of the connecting elements 24, 25 and at least one of the weighing plate segments 16, 17, 18 are connected by means of at least two load elements 26 running substantially parallel.

A further advantageous embodiment of the method is characterised in that the length L_{G1} of the objects 11 is less than and/or equal to the length L_{W1} of the first weighing plate segment 16 and in that the length L_{G2} of the objects 11 is less than and/or equal to the length L_{W1}+L_{W2} of the first weighing plate segment 16 and of the second weighing plate segment 17, and in that the length L_{Gn} of the objects 11 is less than and/or equal to the length L_{W1}+L_{W2}+L_{Wn} of the first weighing plate segment 16, of the second weighing plate segment 17 and of the or each further weighing plate segment 18.

Further preferably, on the basis of the lengths L_{G1}, L_{G2}, L_{Gn} of the object 11 detected by the detecting unit 20, the corresponding weighing signal of the corresponding length L_{W1}, L_{W1}+L_{W2} or L_{W1}+L_{W2}+L_{Wn} of the weighing plate segments 16, 17, 18 is used for weight determination. In a further advantageous configuration, the transport speed is controlled and/or regulated on the basis of the length L_{G1}, L_{G2}, L_{Gn} of the objects 11 and/or the length L_{W1}, L_{W2}, L_{Wn} of the weighing plate segments 16, 17, 18. The objects 11 can additionally be arranged spaced apart from one another on the transport element 13, wherein the spacing from one another is adjusted on the basis of the length L_{G1}, L_{G2}, L_{Gn} of the objects 11 and/or the length L_{W1}, L_{W2}, L_{Wn} of the weighing plate segments 16, 17, 18 and/or the transport speed. Preferably, the spacing between the objects 11 is substantially constantly adjusted independently of the length of the objects 11 L_{G1}, L_{G2}, L_{Gn} and/or the length L_{W1}, L_{W2}, L_{Wn} of the weighing plate segments 16, 17, 18 and/or of the transport speed.

1-26. (canceled)

27. An apparatus, configured and adapted for weighing objects of different lengths, in particular foodstuffs, comprising:
a transport device having at least one transport element, configured and adapted for transporting the objects at a transport speed in a transport direction;
a weighing device arranged under the at least one transport element, configured and adapted for determining a weight of an object transported by the transport device, wherein the weighing device comprises;
a weighing plate comprising at least two separate weighing plate segments arranged under the at least one transport element one behind the other in the transport direction, wherein the at least two weighing plate segments each have a length L_{W1}, L_{W2}, L_{Wn};
a detecting device, upstream of the weighing device in the transport direction, comprising at least one detecting unit, configured and adapted at least to detect a length L_{G1}, L_{G2}, L_{Gn} of each object;
wherein;
a first one of the weighing plate segments in the transport direction comprises at least one weighing cell and is configured and adapted for generating a weighing signal of one of the objects having a maximum length L_{G1};
a further one of the weighing plate segments arranged downstream of the first weighing plate segment in the transport direction is connected to the first weighing plate segment by a first connecting element comprising at least one weighing cell, and is configured and adapted for generating a weighing signal of one of the objects having a maximum length L_{G1} and/or L_{G2}.

28. The apparatus according to claim 27, wherein each of additional ones of the weighing plate segments arranged downstream in the course of the transport direction is connected at least to the preceding first connecting element by a further connecting element comprising at least one weighing cell, and is configured and adapted for generating a weighing signal of one of the objects having a maximum length L_{G1} and/or L_{G2} and/or L_{Gn}.

29. The apparatus according to claim 27, wherein the first and/or the further one of the weighing plate segments arranged in the course of the transport direction is connected in a mechanically supported manner to the first connecting element arranged in the transport direction and is configured and adapted for transmitting a weight force.

30. The apparatus according to claim 27, wherein the first connecting element in the transport direction is connected to the weighing cell of the first weighing plate segment.

31. The apparatus according to claim 28, wherein:
the length L_{G1} of one of the objects is less than and/or equal to the length L_{W1} of the first weighing plate segment;
the length L_{G2} of one of the objects is less than and/or equal to the length L_{W1}+L_{W2} of the first weighing plate segment and of the further weighing plate segment; and
the length L_{Gn} of one of the objects is less than and/or equal to the length L_{W1}+L_{W2}+L_{Wn} of the first weighing plate segment, of the further weighing plate segment and of the or each additional weighing plate segment.

32. The apparatus according to claim 27, wherein:
weighing plate comprising at least two separate weighing plate segments comprises three to seven weighing plate segments; and
starting from a second one of the weighing plate segments in the transport direction, in each case a connecting element is provided for connecting at least one of the weighing plate segments to the first connecting element.

33. The apparatus according to claim 27, wherein the at least one detecting unit is configured and adapted as a scanning system, wherein the scanning system comprises at least one camera and/or at least one laser measuring device.

34. The apparatus according to claim 27, wherein the first connecting element is plate-like.

35. The apparatus according to claim 27, wherein the connection between the first connecting elements and the weighing plate segments comprises at least two load elements running substantially parallel to one another.

36. The apparatus according to claim 35, wherein the load elements running substantially parallel to one another are substantially orthogonal to the transport element.

37. The apparatus according to claim 27, wherein the objects are fish fillets having a length of 200 mm to 900 mm.

38. The apparatus according to claim 31, wherein, on a basis of the lengths L_{G1}, L_{G2}, L_{Gn} of the objects detected by the detecting unit, a corresponding weighing signal of the corresponding length L_{W1}, L_{W1}+L_{W2} or L_{W1}+L_{W2}+L_{Wn} of the weighing plate segments is used for weight determination.

39. The apparatus according to claim 27, wherein the transport speed is configured and adapted to be controllable and/or regulable on a basis of the length L_{G1}, L_{G2}, L_{Gn} of the objects and/or the length L_{W1}, L_{W2}, L_{Wn} of the weighing plate segments.

40. The apparatus according to claim 27, wherein:
the objects are arranged spaced apart from one another on the transport element; and
the spacing from one another is configured and adapted to be adjustable on a basis of the length L_{G1}, L_{G2}, L_{Gn} of the objects and/or the length L_{W1}, L_{W2}, L_{Wn} of the weighing plate segments and/or the transport speed.

41. The apparatus according to claim 40, wherein the spacing between the objects is configured and adapted to be substantially constantly adjustable independently of the length of the objects L_{G1}, L_{G2}, L_{Gn} and/or the length L_{W1}, L_{W2}, L_{Wn} of the weighing plate segments and/or of the transport speed.

42. A method for weighing objects of different lengths L_{G1}, L_{G2}, L_{Gn}, in particular foodstuffs, comprising the steps of:
transporting the objects at a transport speed in a transport direction by a transport device having at least one transport element;
determining a weight of the objects transported by the transport device using a weighing device, wherein the weighing device comprises;
a weighing plate comprising at least two separate weighing plate segments which are arranged under the at least one transport element one behind the other in the transport direction T, wherein the at least two weighing plate segments each have a length L_{W1}, L_{W2}, L_{Wn},
detecting the lengths L_{G1}, L_{G2}, L_{Gn} of the objects by a detecting device, upstream of the weighing device in the transport direction, comprising at least one detecting unit;
wherein;
the weighing signal of one of the objects of a maximum length L_{G1} is generated by a weighing cell comprising a first one of the weighing plate segments in the transport direction; and
a weighing signal of one of the objects of a maximum length L_{G1} and/or L_{G2} is generated by a further one of the weighing plate segments comprising at least one weighing cell, downstream of the first weighing plate segment in the transport direction, wherein the first weighing plate segment is connected to the downstream further weighing plate segment by a first connecting element.

43. The method according to claim 42, wherein the weighing signal of one of the objects of a maximum length L_{G1} and/or L_{G2} and/or L_{Gn} is generated by each of additional ones of the weighing plate segments, comprising the at least one weighing cell, downstream in the transport direction, wherein each of the additional weighing plate segments comprises in each case a further connecting element and is connected to a preceding one of the connecting elements.

44. The method according to claim 42, wherein the first and/or the further weighing plate segment arranged in the transport direction is connected in a mechanically supported manner to the first connecting element arranged in the course of the transport direction, a weight force being transmitted.

45. The method according to claim 42, wherein the first connecting element in the transport direction is connected to the weighing cell of the first weighing plate segment.

46. The method according to claim 43, wherein:
the length L_{G1} of one of the objects is less than and/or equal to the length L_{W1} of the first weighing plate segment; and
the length L_{G2} of one of the objects is less than and/or equal to the length L_{W1}+L_{W2} of the first weighing plate segment and of the further weighing plate segment; and
the length L_{Gn} of one of the objects is less than and/or equal to the length L_{W1}+L_{W2}+L_{Wn} of the first weighing plate segment, of the further weighing plate segment and of the or each additional weighing plate segment.

47. The method according to claim 42, wherein the connection between the first connecting elements and the weighing plate segments comprises at least two load elements running substantially parallel.

48. The method according to claim 42, wherein the objects are fish fillets having a length of 200 mm to 900 mm.

49. The method according to claim 42, wherein, on a basis of the lengths L_{G1}, L_{G2}, L_{Gn} of the objects detected by the detecting unit, a corresponding weighing signal of the corresponding length L_{W1}, L_{W1}+L_{W2} or L_{W1}+L_{W2}+L_{Wn} of the weighing plate segments is used for weight determination.

50. The method according to claim 42, wherein the transport speed is controlled and/or regulated on a basis of the length L_{G1}, L_{G2}, L_{Gn} of the objects and/or the length L_{W1}, L_{W2}, L_{Wn} of the weighing plate segments.

51. The method according to claim 42, wherein:
the objects are arranged spaced apart from one another on the transport element; and
the spacing from one another is adjusted on a basis of the length L_{G1}, L_{G2}, L_{Gn} of the objects and/or the length L_{W1}, L_{W2}, L_{Wn} of the weighing plate segments and/or the transport speed.

52. The method according to claim 51, wherein the spacing between the objects is substantially constantly adjusted independently of the length of the objects L_{G1}, L_{G2}, L_{Gn} and/or the length L_{W1}, L_{W2}, L_{Wn} of the weighing plate segments and/or of the transport speed.
